(19) United States
(12) Patent Application Publication
(10) Pub. No.: US 2024/0381495 A1
(43) Pub. Date: Nov. 14, 2024

(54) HEATING ROD

(71) Applicant: BorgWarner Emissions Systems Spain S.L.U., Vigo (ES)

(72) Inventors: Matías Baleato, Vigo (ES); Iago Gonzáles Tabarés, Vigo (ES); Ignacio Parada, Vigo (ES); Mauricio Xurxo Pérez, Vigo (ES); Luis Carvalho, Vigo (ES)

(21) Appl. No.: 18/653,237

(22) Filed: May 2, 2024

(30) Foreign Application Priority Data
May 12, 2023 (EP) 23 173 071.4

(51) Int. Cl. H05B 3/42; F24H 3/04; H05B 3/06; H05B 3/14

(52) U.S. Cl. CPC H05B 3/42; H05B 3/06; H05B 3/141; F24H 3/0435; H05B 2203/02

(57) ABSTRACT

Disclosed is a heating rod having a tubular housing made of metal, a plurality of ceramic heating elements arranged inside the housing, a plastic frame holding the heating elements, and a metallic strip that is electrically isolated from the housing and electrically contacts the heating elements. The housing has crimped sections that fix the plastic frame inside the housing.

### RELATED APPLICATIONS

This application claims priority to EP 23 173 071.4, filed May 12, 2023, the entire disclosure of which is hereby incorporated herein by reference.

### BACKGROUND AND SUMMARY

This disclosure refers to a heating rod of the type generally known in the art in, e.g., U.S. Pat. No. 11,197,349 B2.

Such heating rods are used in cabin heaters of cars. It has been found that failure of such heating rods is sometimes caused by relative movement between the tubular housing and components inside the tubular housing which damages electrical isolation. In prior art heating rods, such relative movement is usually caused by different thermal expansion of the tubular housing and components arranged therein.

This disclosure teaches a heating rod with an improved lifetime.

In a heating rod according to this disclosure, the tubular housing is crimped and thereby movement of a plastic frame that holds ceramic heating elements relative to the tubular housing is prevented or least severely restricted. Crimping in this respect means that the tubular housing is plastically deformed by pinching or compressing, whereby the inner cross-section of the tubular housing is locally reduced and thereby a stop is created which blocks movement of the frame relative to the housing.

In an advantageous refinement of this disclosure, there are two crimped sections, one adjacent to each end of the tubular housing. In such an embodiment all ceramic heating elements are arranged between the crimped sections.

In a further advantageous refinement of this disclosure, the plastic frame has a recess which one of the crimped sections engages. The recess may be a groove, e.g., a circumferential groove, a groove on one side of the plastic frame or a groove on opposite sides of the plastic frame. During the crimping process, material of the tubular housing is pressed inward into the recess. Thereby a positive lock can be created which fixes the plastic frame relative to the tubular housing. The plastic frame may have only one such recess or the plastic frame may have two or more such recesses that are engaged by crimped sections of the tubular housing.

In addition to a recess or instead of a recess engaged by crimped sections of the tubular housing, an end of the plastic frame may be arranged between one of the crimped sections and the plurality of ceramic heating elements. The crimped section then creates an abutment for the adjacent end of the plastic frame. In a refined embodiment of this disclosure, the plastic frame may have an increased width and/or thickness between such a crimped section and the plurality of heating elements. The increased thickness and/or width of the plastic frame protects the ceramic heating elements during the crimping process and can prevent cracking of ceramic heating elements.

The plastic frame may be provided with a step in order to locally increase thickness and/or width. However, the ceramic heating elements can be protected better from mechanical stress during the crimping process if the plastic frame tapers from its increased thickness and/or width towards the ceramic heating elements. For increased protection of the ceramic heating elements the tapering section may extend over a length that is larger than the maximum width of the tubular housing. The taper angle, i.e., the angle enclosed by the longitudinal direction and the tapering surface, can be rather small, e.g., 10° or less.

In an embodiment of this disclosure, the plastic frame may have a recess, especially a groove, in sections adjacent to each end. In another embodiment of this disclosure, the plastic frame may have a recess, e.g., a groove, adjacent to one end and an increased width and/or thickness adjacent to an opposite end of the tubular housing.

Crimped sections of the tubular housing can prevent relative movement between the plastic frame holding the ceramic heating elements and the tubular housing. Different thermal expansion may also cause relative movement between a metallic strip electrically contacting the ceramic heating elements and an isolating layer that electrically isolates the metallic strip from the tubular housing. Damage from such relative movement may be prevented by providing the contact strip with multiple slits that extend pairwise from opposite edges over more than two thirds of the width of the strip, e.g., over 80% to 90% of the width of the strip. Such slits greatly increase the flexibility of the strip such that it can easily extend or contract in its lengthwise direction and thereby mitigate any thermally induced stress. Flexibility of the strip can be increased even further if the slits are broadened at their ends away from the edge where they start. For example, the slits may end in a circular hole, e.g., a hole with a diameter of 2.0 mm to 4.0 mm. In addition or in the alternative, flexibility of the strip may be improved further if the slits comprise a first section curved in a first direction and a second section curved into an opposite direction. For example, slits may be S-shaped.

In an advantageous further refinement of this disclosure, the slits may have a width of 0.7 mm to 1.3 mm. As both ends of the slits may be broadened, the width of the slits has been measured in a central section that connects the ends of the slits. The central section extends over at least 90% of the total length of a slit.

In an advantageous further refinement, the slits are parallel to each other and the distance between slits of a pair may be two to three times as large as the width of the slits.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows an exploded view of a heating rod;

FIG. 2 shows schematically a cross-sectional view of a first end of the heating rod;

FIG. 3 shows schematically a cross-sectional view of a second end of the heating rod;

FIG. 4 shows a metallic strip of FIG. 1; and

FIG. 5 shows a detail of FIG. 4.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

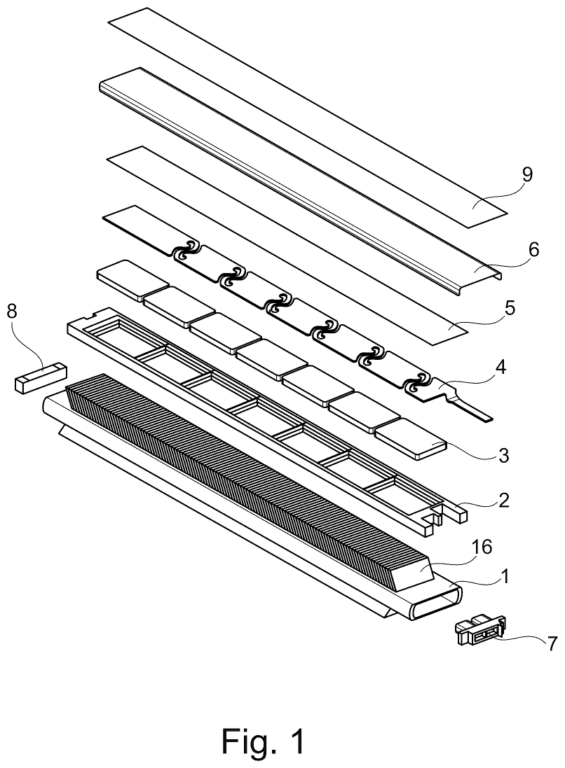

The heating rod shown in FIG. 1 in an exploded view comprises a tubular housing 1 made of metal, a plastic frame 2 holding ceramic heating elements 3, e.g., PTC heating resistors, a metallic strip 4 electrically contacting the heating elements 3, and an isolation layer 5 electrically isolating the metallic strip 4 from the housing 1. In the embodiment shown the isolation layer 5 may be a ceramic layer. There may be one or more additional isolation layers 6, 9, for example isolation layers made of plastic, e.g., polyimide. The tubular housing 1 may be closed at one or both ends with plugs, caps or sealant, e.g., silicone sealant, 7, 8.

In the embodiment shown, the tubular housing 1 is shaped as a flat tube, i.e., it has two opposing broad sides that are connected by narrow sides. The broad sides of the tubular housing 1 are provided with fins 16 in order to facilitate transport of heat created by the heating elements 3 to ambient air. Such fins 16 may be provided integrally with the tubular housing 1 by skiving or may be provided as separate parts attached to the tubular housing.

In the embodiment shown, there is only a single metallic strip 4 electrically contacting the ceramic heating elements 3. Mass contact of the ceramic heating elements 3 is provided by the tubular housing 1. It is also possible to provide a second metallic strip that is electrically isolated from the housing. The heating elements 3 are then arranged between these metallic strips and thereby connected to potential and to mass.

During assembly a stack is formed of the ceramic heating elements 3 held by the plastic frame 2, the strip 4, and any isolation layers 5, 6, 9. This stack may comprise a second metallic strip and one or more additional isolating layers if the ceramic heating elements are not electrically contacted by the tubular housing 1. This stack is then inserted into the tubular housing 1. The tubular housing 1 may then be compressed in order to improve thermal contact of the stack to the tubular housing 1 by applying pressure the broad sides of the tubular housing 1. The broad sides of the tubular housing 1 are provided with fins 16 and are facing the major sides of the plate shaped ceramic heating elements 3.

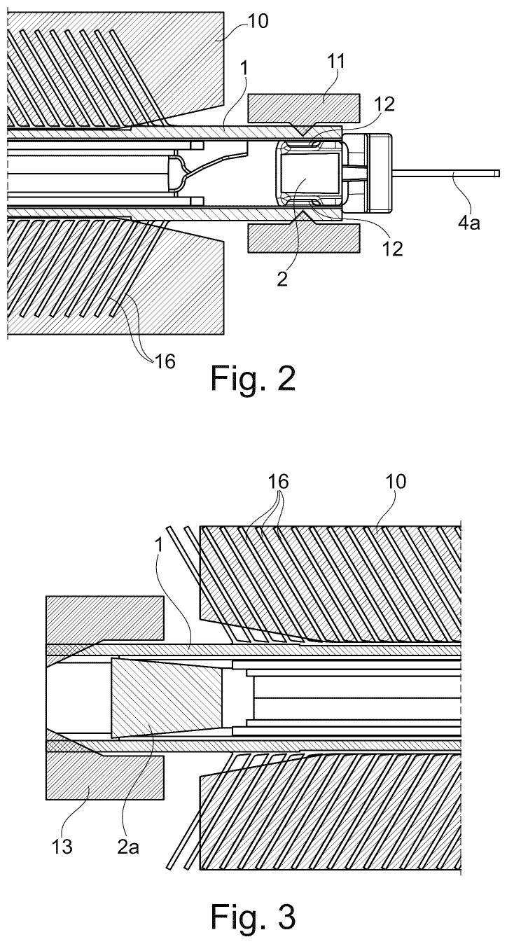

FIG. 2 shows schematically a first end of the tubular housing 1 with the inserted stack comprising the plastic frame 2. The first end of the tubular housing 1 is the end where an electrical terminal 4a protrudes from the housing, e.g., an extension of the metallic strip 4. Also shown is a pressing tool 10 for compressing the tubular housing 1 and thereby improving thermal contact of the ceramic heating elements 3 to the tubular housing 1.

Movement of the plastic frame 2 inside the tubular housing 1 can be minimized by crimping sections of the tubular housing 1, especially a section adjacent to the ends of the tubular housing 1. FIG. 2 shows schematically a tool 11 crimping a section of the tubular housing 1. The plastic frame 2 has a recess 12, e.g., a groove. Tool 11 crimps a section of the tubular housing 1 by pressing material of the housing inwards into recess 12. Thus the crimped section of the tubular housing 1 engages recess 12. Thereby a positive lock is created between the tubular housing 1 and the plastic frame 2.

FIG. 3 shows schematically a second end of the tubular housing 1 with the inserted stack comprising the plastic frame 2 together with the pressing tool 10 for compressing the tubular housing 1. Also shown is a tool 13 for crimping an end section of the tubular housing 1 in order to minimize movement of the plastic frame 2 relative to the tubular housing 1.

The plastic frame 2 has a section 2a with an increased thickness. In the embodiment shown the thickness of the plastic frame 2 increases away from the ceramic heating elements towards the end. That is the plastic frame 2 tapers toward the ceramic heating elements. Tool 13 is used to crimp an end section of the tubular housing 1 thereby creating an abutment for the plastic frame 2.

FIGS. 2 and 3 show different possibilities for shaping the plastic frame 2 in order to prevent movement inside the tubular housing 1. It is possible to configure one end of a heating rod according to FIG. 2 and the other end according to FIG. 3, but it is also possible to provide a recess according to FIG. 2 at both ends or an increased thickness according to FIG. 3 at both ends.

In a heating rod according to FIGS. 2 and 3 all ceramic heating elements are arranged between two crimped sections which are arranged at or adjacent to the ends of the heating rod. These crimped sections prevent or at least reduce movement of the plastic frame 2 inside the tubular housing 1 and thereby improve the lifetime of a heating rod.

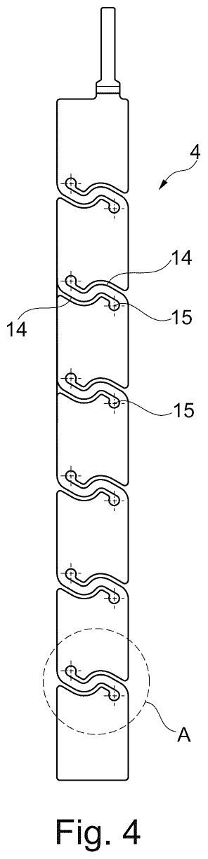

FIG. 4 shows a metallic strip 4 for electrically contacting ceramic heating elements, e.g., a strip made of aluminum or copper. This metallic strip 4 has multiple slits 14 that extend pairwise from opposite edges over more than two thirds of the width of the strip 4. These slits 14 increase flexibility of the strip 4. Mechanical stresses caused by different thermal expansion of the various components of the heating rod, especially the metallic strip 4, ceramic heating elements, isolating layers and tubular housing, can therefore more easily alleviated by longitudinal expansion or compression of the metallic strip 4.

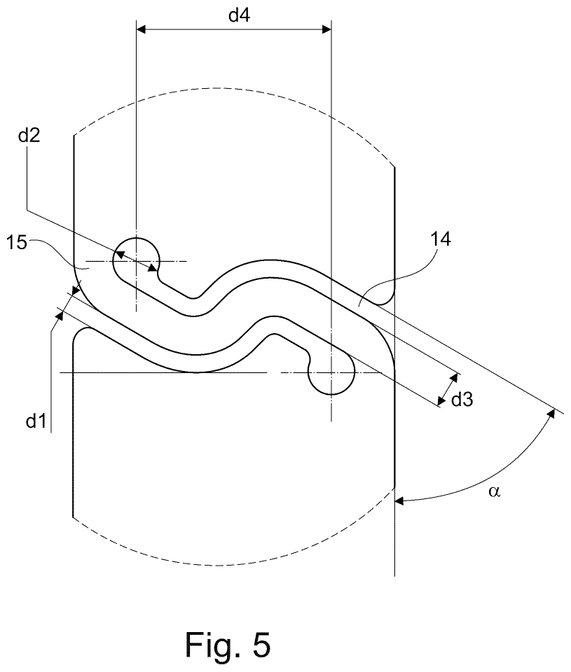

FIG. 5 shows a detail A of FIG. 4. As can be seen therein, the slits 14 are broadened at their ends away from the edge where they start. The broadened ends may be provided as circular holes 15 that have a diameter that is larger than the width of the slit 14, e.g., two to four times as large. Moreover, the slits 14 comprise a first section curved in a first direction and a second section curved into an opposite direction. Thus the slits 14 are S-shaped. The curved section may connect to straight sections of the slits 14. As shown in FIG. 5, such straight sections enclose an angle α with the longitudinal direction of the strip 14 that is less than 90°, e.g., 55° to 80°.

Both the broadened ends and the curved sections improve flexibility of the strip metallic strip 4 and thereby help alleviating mechanical stresses. The curved sections of the slits may have a width d1 of 0.7 to 1.3 mm, for example. The broadened ends or circular holes at the end of the slits 14 may have a diameter d2 of 2.0 mm to 4.0 mm, for example.

The slits 14 are arranged such that they cover only one of the ceramic heating elements 3 each. That is the slits 14 do not cross from one ceramic heating element 3 to an adjacent heating element. For example, the slits 14 may be arranged over a central section of a ceramic heating element 3. In this way good electrical contact between the metallic strip 4 and the ceramic heating elements 3 is ensured. In the embodiment shown, the slits 14 extend pairwise from opposite edges over more than two thirds of the width of the strip 14, e.g., over 80% to 90% of the width of the strip 14. The slits 14 of each pair may be parallel to each other and be arranged at a distance d3 that is two to three times as large as the width d1 of the slits 14. Between the centers of circular holes 15 at the end of a pair of slits 14 may be a distance d4 measured in a direction perpendicular to the longitudinal direction of the strip 14, said distance d4 that is 55% to 70% of the width of the strip 14 for example.

The slits 14 may be cut into the strips 4 with a laser or mechanically, for example.

The plastic frame 2 may be made of plastic, especially fiber-reinforced plastic. Polyphenylene sulfide may be used for example, especially with a fiber content of 10% to 50%, e.g., 10% to 50% by weight of glass fiber or 10% to 40% by weight of carbon fiber.

The metallic strip 4 may be made on materials based on aluminum or copper, e.g., Al—Mg alloys, Cu—Ni alloys or Cu—Fe alloys.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SIGNS

1 tubular housing.
2 plastic frame.
2a section of plastic frame
3 ceramic heating elements
4 metallic strip
4a terminal
5 isolation layer
6 isolation layer
7 end cap
8 sealant
9 isolation layer
10 tool
11 tool
12 recess
14 slit
15 holes
16 fins

What is claimed is:

1. A heating rod, comprising:
a tubular housing made of metal;
a plurality of ceramic heating elements arranged inside the housing;
a plastic frame holding the heating elements; and
a metallic strip electrically isolated from the housing and electrically contacting the heating elements;
wherein, the housing has crimped sections that fix the plastic frame inside the housing.

2. The heating rod according to claim 1, wherein all ceramic heating elements are arranged between the crimped sections.

3. The heating rod according to claim 1, wherein the plastic frame has a recess which one of the crimped sections engages.

4. The heating rod according to claim 3, wherein the recess is a groove.

5. The heating rod according to claim 1, wherein the plastic frame has a section of increased thickness between one of the crimped sections of the housing and the plurality of ceramic heating elements.

6. The heating rod according to claim 5, wherein the plastic frame tapers from the section of increased thickness towards the plurality of ceramic heating elements.

7. The heating rod according to claim 1, wherein the housing is a flat tube.

8. The heating rod according to claim 1, wherein the housing has opposing broad sides that are connected by narrow sides, wherein fins are provided at the broad sides.

9. The heating rod according to claim 1, wherein the metallic strip has multiple slits that extend pairwise from opposite edges and are broadened at their ends away from the edge where they start.

10. The heating rod according to claim 9, wherein the slits comprise a first section curved in a first direction and a second section curved in an opposite direction.

11. The heating rod according to claim 9, wherein each slit covers only one of the ceramic heating elements.

12. The heating rod according to claim 9, wherein the broadened ends of the slits comprise circular holes that have a diameter that is larger than a section of the slit leading to the end.

13. The heating rod according to claim 9, wherein the slits comprise straight sections that enclose an angle of less than 90° with a longitudinal direction of the strip.

14. The heating rod according to claim 1, wherein the plastic frame is made of fiber-reinforced polyphenylene sulfide.

15. The heating rod according to claim 14, wherein the frame comprises 10% to 50% by weight of glass fiber or 10% to 40% by weight of carbon fiber.

16. A heating rod, comprising:
a tubular housing made of metal;
a plurality of ceramic heating elements arranged inside the housing;
a plastic frame holding the heating elements; and
a metallic strip electrically isolated from the housing and electrically contacting the heating elements;
wherein, the housing has crimped sections that fix the plastic frame inside the housing; and
wherein, the metallic strip has multiple slits that extend pairwise from opposite edges and are broadened at their ends away from the edge where they start.

17. A heating rod, comprising:
a tubular housing made of metal;
a plurality of ceramic heating elements arranged inside the housing;
a plastic frame holding the heating elements; and
a metallic strip electrically isolated from the housing and electrically contacting the heating elements;
wherein, the housing has crimped sections that fix the plastic frame inside the housing;
wherein, the plastic frame has a section of increased thickness between one of the crimped sections of the housing and the plurality of ceramic heating elements; and
wherein, the plastic frame tapers from the section of increased thickness towards the plurality of ceramic heating elements.
